(19) United States
(12) Patent Application Publication
(10) Pub. No.: US 2002/0085649 A1
(43) Pub. Date: Jul. 4, 2002

(54) System and method for controlling operation mode of an adaptive equalizer

(76) Inventor: Yong-Suk Hwang, Ichon-shi (KR)

Correspondence Address: MARSHALL, GERSTEIN & BORUN, 6300 SEARS TOWER, 233 SOUTH WACKER, CHICAGO, IL, 60606-6357, US

(21) Appl. No.: 09/929,948

(22) Filed: Aug. 15, 2001

(30) Foreign Application Priority Data
Aug. 17, 2000 (KR) 2000-47403

(51) Int. Cl. H04L 25/10; H04L 25/06

(52) U.S. Cl. 375/319

(57) ABSTRACT

A system for the controlling the operational mode of an adaptive equalizer quickly determines the operational mode of the adaptive equalizer by measuring the amplitude variation of a DC offset for every segment. The system includes a DC estimator for estimating a DC value of a baseband signal, a maximum outputting circuit and a minimum outputting circuit for extracting a maximum DC value and a minimum DC value from the estimated DC value, an initializing circuit for initializing the maximum outputting circuit and the minimum outputting circuit, an operating circuit for obtaining a difference between the maximum DC value and the minimum DC value, a computing circuit for obtaining a median value between the maximum DC value and the minimum DC value, a storing circuit for outputting a threshold corresponding to the median value, a comparator for comparing the difference between the maximum DC value and the minimum DC value with the threshold, and a controller for changing the operational mode of the adaptive equalizer.

### FIELD OF THE INVENTION

The present invention relates to an adaptive equalizer and, more particularly, to a system and method for controlling the operational mode of an adaptive equalizer based on a characteristic of a signal received at a digital television receiver.

### PRIOR ART

As is known, either a training mode, which uses a training sequence for field synchronization, or a blind mode, which does not use a training sequence for synchronization, may be used to check a received signal to determine appropriate coefficients for the operational modes of an adaptive equalizer. The training mode and the blind mode lead to different performance depending on the received signal characteristic and, in general, operating in the training mode (except in the case of a moving ghost signal) is good for error performance. The training mode operates repeatedly for a short period during the field, while the blind mode operates during the whole field. As a result, power consumption in the blind mode is higher than power consumption in the training mode.

A broadcast television (TV) signal includes a pilot signal having a DC value as well as a data signal having multi-level symbols and fixed PN (pseudo random) sequence used as a field synchronization signal. Conventionally, the DC variation of a signal obtained during field synchronization represents variation of a received ghost signal.

The equalizer uses the field synchronization signal as a training sequence to update tap coefficients when the ghost signal is below 5 Hz fixed or is moving slowly and uses the blind mode when the ghost signal is moving fast because the method using the field synchronization signal does not operate fast.

FIG. 1 is a block diagram of a digital TV receiver employing a conventional system for controlling an adaptive equalizer. A tuner 1 receiving a digital signal applies a selected channel signal to a SAW filter 2. The SAW filter 2 truncates the received signal from the tuner 1 to eliminate an image signal generated at the tuner 1 and outputs the truncated signal to a demodulator 3 where the output of the SAW filter 2 is shifted to a baseband signal. The demodulator 3 applies the baseband signal to an ADC (analog/digital converter) 4 that converts the baseband signal to a digital signal. The digital signal from the ADC 4 is applied to a timing unit 5 to obtain a timing signal T256 or to an adaptive equalizer 6 where the ghost signal is eliminated and outputted to a next stage (not shown). The timing signal T256 from the timing unit 5 is applied to a gate 7 that is triggered by the timing signal T256.

The format of the output signal of the demodulator 3, as shown in FIG. 2, includes a frame consisting of two fields, each of which consists of 313 segments. Each segment consists of 832 symbols. The first segment of each field is the field synchronization signal and the remaining 312 segments are data segments. The first segment of each field includes 511, 63, 63, 63 PN sequences.

Returning to FIG. 1, the timing signal T256 is a signal that directs the remaining 256 symbols of 511 PN sequence among the sequence of the field segment to be outputted to a memory 8 through the gate 7, the 256 symbols being used to measure the DC variation. A DC offset computing unit 10, which may be implemented using a software algorithm, determines X, which represents the DC offset, by using the 256 symbols from the memory 8. The value X is compared to a threshold K by a comparator 11 and the comparison result is used to determine the operational mode of the adaptive equalizer 6 via a LUT (Look-Up Table) 9. If the X value is larger than the threshold K at the comparator 11, the adaptive equalizer 6 operates in the blind mode, otherwise, the adaptive equalizer 6 operates in the training mode.

FIG. 3 shows a flow chart of DC offset computation in the DC offset computation unit 10. At step 12, the 256 symbols are received. At step 13, the 256 symbols are summed and then divided by 256 to generate a sample. At step 14, 30 sequential samples for sequential field synchronization are obtained and an average of the 30 samples is computed. At step 15, the average is subtracted from each sample. At step 16, each of the subtracted values is squared and the squared values are summed to generate the value X. Because the 256 symbols are a two-level random sequence, the summed value at step 13 is about zero when the pilot signal (DC value) does not exist. Therefore, the sample is influenced by the DC value.

As described above, the DC value is conventionally estimated by using 256 symbols during field synchronization and the operational mode of the adaptive equalizer is determined based on the DC value. However, it takes 0.7 second to obtain the 30 samples because the sample is obtained for the field synchronization spaced by 24.2 milliseconds. In other words, the operational mode of the adaptive equalizer can be determined and the tap coefficients can be changed only after 0.7 second has elapsed. Because the DC value may be changed depending on the structure of the receiver, e.g., the receiver including a matched filter before a carrier recovering block and a frequency offset exists, the simple comparison of the DC value to the threshold K could mislead the operational mode of the adaptive equalizer. Further, because a 40 Hz (1/24 millisecond) sample rate is used, the DC variation may be missed when the channel changes at a rate greater than about 40 Hz. Additionally, because the software algorithm is used by the micro-controller to compute the DC offset, the micro-controller controlling a receiver chip may be overloaded (i.e., could become a processing bottleneck).

### SUMMARY OF THE INVENTION

A system for controlling the operational mode of an adaptive equalizer quickly determines the operational mode of the adaptive equalizer by measuring the amplitude variation of a DC offset for every segment. The system may be implemented using simple hardware without requiring a separate software algorithm.

In accordance with one aspect of the invention, a system for controlling an adaptive equalizer comprises: a DC estimator for estimating a DC value included in a received baseband signal; a maximum outputting circuit for extracting a maximum DC value from the estimated DC value from the DC estimator; a minimum outputting circuit for extracting a minimum DC value from the estimated DC value from the DC estimator; an initializing circuit for initializing the maximum outputting circuit and the minimum outputting circuit to a new DC value applied at every a predetermined number of fields; an operating circuit coupled to the maximum outputting circuit and the minimum outputting circuit for obtaining a difference between the maximum DC value and the minimum DC value; a computing circuit coupled to the maximum outputting circuit and the minimum outputting circuit for obtaining a median value between the maximum DC value and the minimum DC value; a storing circuit for storing thresholds for the DC value and outputting one of the thresholds corresponding to the median value from the computing circuit; a comparator for comparing the difference between the maximum DC value and the minimum DC value from the operating circuit with the threshold outputted from the storing circuit; and a controller for changing the operational mode of the adaptive equalizer to a blind mode when the difference between the maximum DC value and the minimum DC value is larger than the threshold in response to a comparison result from the comparator and changing the operational mode of the adaptive equalizer to a training mode when a count number is larger than a predetermined number after a counting operation operated in response to a segment synchronization signal when the difference between the maximum DC value and the minimum DC value is smaller than the threshold.

In accordance with another aspect of the invention, a method for controlling operational modes of an adaptive equalizer comprises the steps of: estimating a DC value from a received baseband signal; obtaining a maximum DC value and a minimum DC value from the estimated DC value; comparing a difference between the maximum DC value and the minimum DC value with a threshold responsive to the estimated DC value; changing the operational mode of the adaptive equalizer to a blind mode if the difference between the maximum DC value and the minimum DC value is larger than the threshold; counting a count number in response to a segment synchronization signal if the difference between the maximum DC value and the minimum DC value is smaller than the threshold; comparing the count number with a number predetermined by a system designer; and changing the operation mode of the adaptive equalizer to a training mode if the counter number is larger than the predetermined number after repeating counting if the difference between the maximum DC value and the minimum DC value is smaller than the threshold.

### BRIEF DESCRIPTION OF THE DRAWINGS

FIG. 1 is a block diagram of a digital TV receiver employing a conventional system for controlling an adaptive equalizer;

FIG. 2 is a format diagram of an output signal of a demodulator;

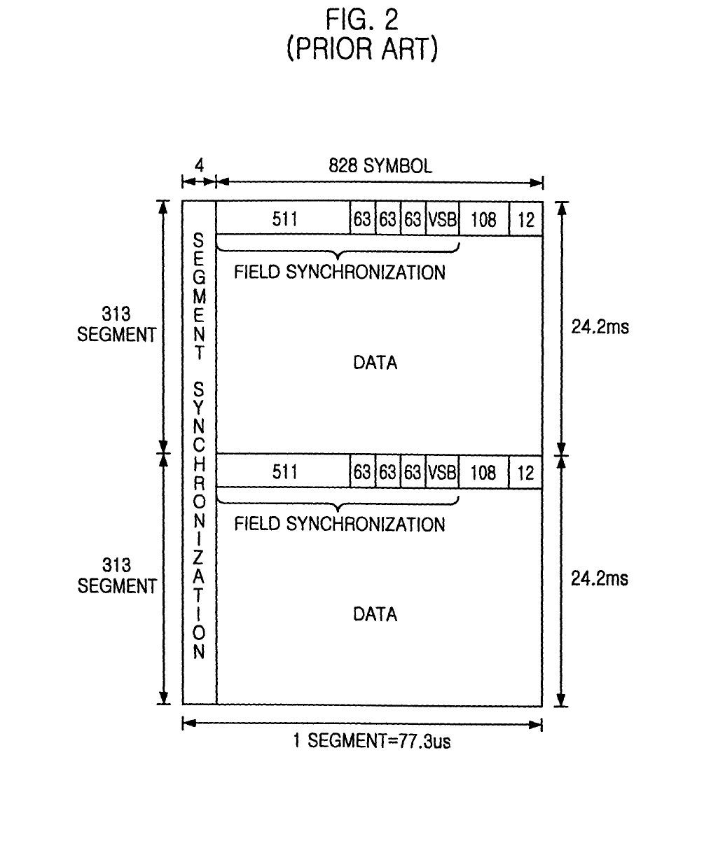

FIG. 3 shows a flow chart for DC offset computation in a DC offset computation unit;

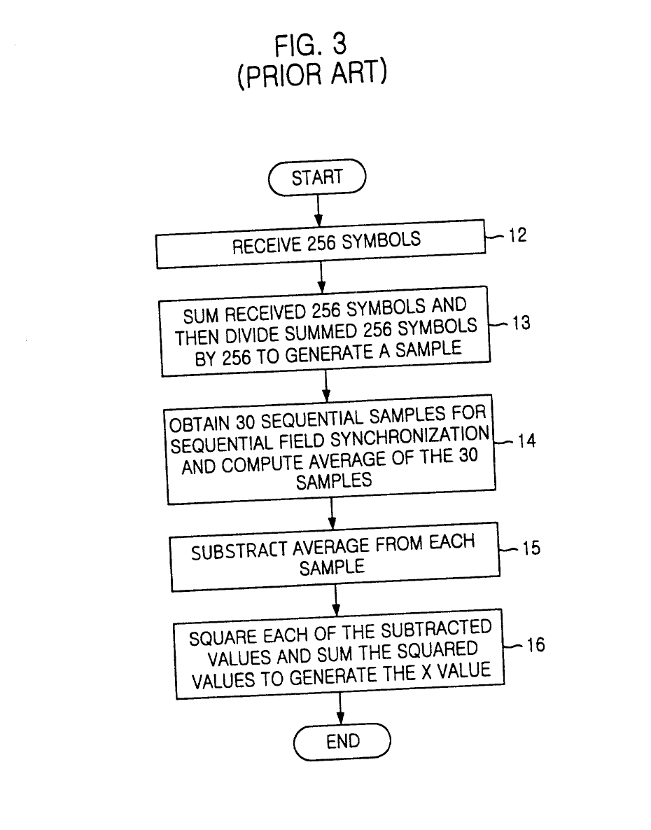

FIG. 4 is an exemplary block diagram of a system for controlling an adaptive equalizer; and

FIG. 5 is a flow chart depicting one manner in which the operational modes of an adaptive equalizer may be controlled.

### DETAILED DESCRIPTION OF THE PREFERRED EMBODIMENTS

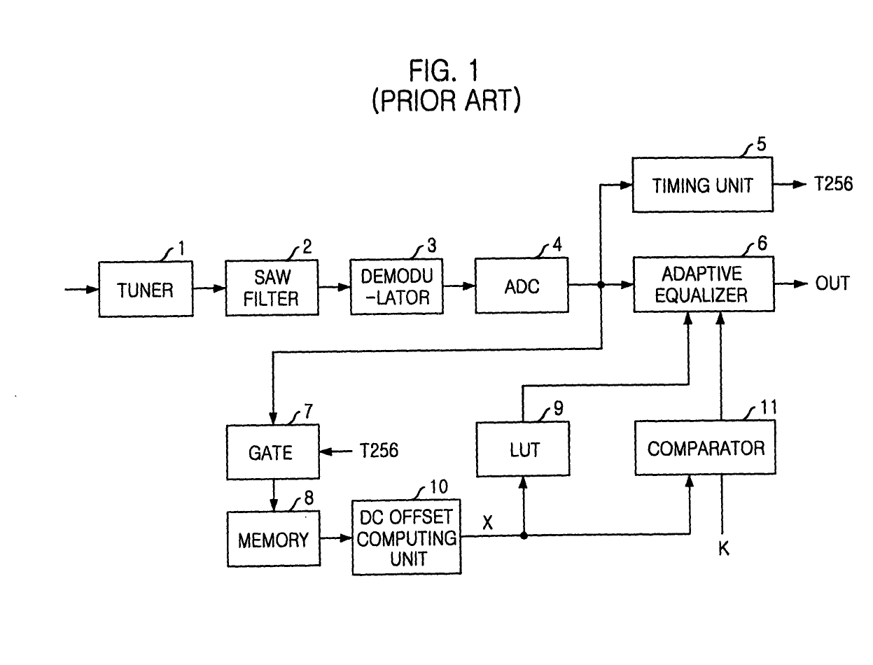

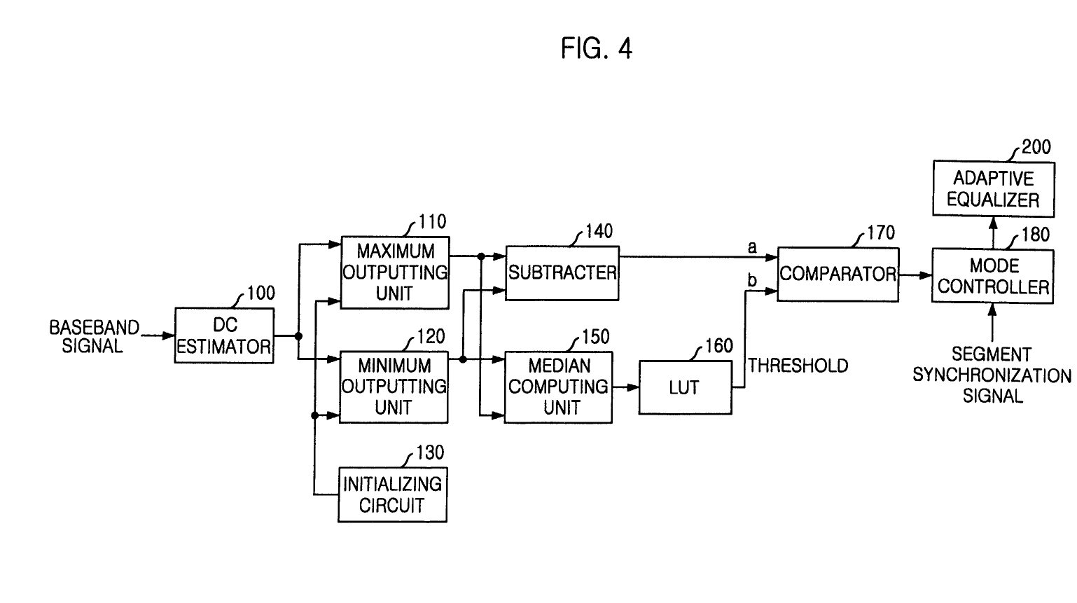

FIG. 4 is an exemplary block diagram of a system for controlling the operational mode of an adaptive equalizer, such as the adaptive equalizer of the digital TV receiver shown in FIG. 1. As shown in FIG. 4, the adaptive equalizer control system described herein comprises a DC estimator 100, a maximum outputting unit 110, a minimum outputting unit 120, an initializing circuit 130, a subtracter 140, a median computing unit 150, a LUT (Look-Up Table) 160, a comparator 170 and a mode controller 180. The DC estimator 100 receives a baseband signal provided through a tuner, a SAW filter, an ADC and a demodultor and estimates a pilot signal (a DC value) that is included within the baseband signal. The maximum outputting unit 110 and the minimum outputting unit 120 receive the estimated DC value, which varies widely when a moving ghost exists, from the DC estimator 100 to extract a maximum value and a minimum value of the estimated DC value, respectively. The initialization circuit 130 initializes the maximum outputting unit 110 and the minimum outputting unit 120 to a new DC value applied at every cycle (i.e., a predetermined period of a field) to check whether the moving ghost still exists. The subtracter 140 is coupled to the maximum outputting unit 110 and the minimum outputting unit 120 to obtain a difference of the maximum DC value and the minimum DC value. The median computing unit 150 adds the maximum DC value and the minimum DC value and divides the added value by two to generate a median value. The LUT 160 receives the median value from the median computing unit 150 and outputs a threshold “b” corresponding to the median value. The comparator 170 compares the value “a” from the subtracter 140 with the value b from the LUT 160 and determines that the moving ghost exists if the value a is larger than the value b and that the moving ghost does not exist if the value b is larger than the value a. The mode controller 180 changes the operational mode of the adaptive equalizer 200 to a blind mode when it is determined that the moving ghost exists in response to the comparison result from the comparator 170. The mode controller 180 changes to a training mode when a counting value becomes larger than a predetermined value during counting operation in response to a segment synchronization signal when it is determined that the moving ghost does not exist in response to the comparison result from the comparator 170. When a is larger than b during the counting operation of the mode controller 180, the count value is reset to zero, which enables fast mode transition of the adaptive equalizer 200 to the blind mode when it is determined that the moving ghost exists.

The initialization circuit 130 initializes the maximum outputting unit 110 and the minimum outputting unit 120 at every 512 field synchronizations (i.e., a period of 512 field synchronizations) at which the maximum outputting unit 110 and the minimum outputting unit 120 obtain new maximum value and minimum value. The initialization period can be determined based on the broadcasting environment. The counting operation of the mode controller 180 has a 100 symbol period (i.e., the sample is obtained at every 100 symbols).

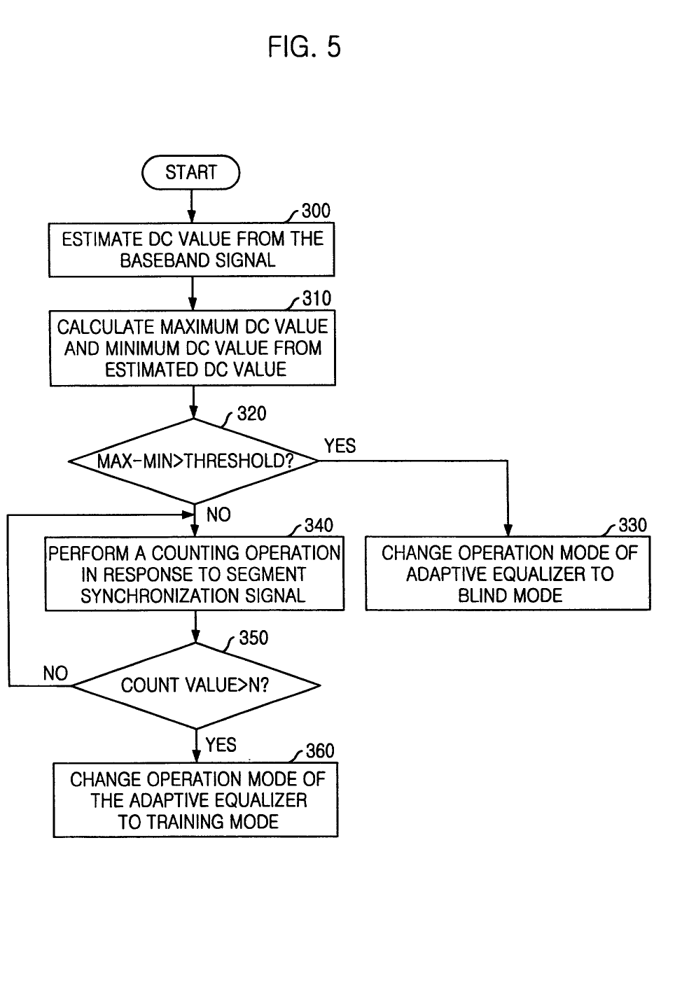

FIG. 5 is an exemplary flow chart depicting one manner in which the operational mode of an adaptive equalizer may be controlled. The DC value is estimated from the baseband signal at step 310. At step 320, the difference between the maximum DC value MAX and the minimum DC value MIN is compared with the threshold. At step 330, the operational mode of the adaptive equalizer is changed to the blind mode if the maximum DC value MAX is larger than the minimum DC value MIN. At step 340, the counting operation is performed in response to the segment synchronization signal if the difference between the maximum DC value MAX and the minimum DC value MIN is smaller than the threshold. At step 350, the count value is compared with a number N, which may be predetermined by a system designer. At step 360, the operational mode of the adaptive equalizer is changed to the training mode if the count value is larger than the N. While the count is below N, the counting operation is repeated.

The control system for an adaptive equalizer described herein can improve error performance and reduce power consumption by measuring the amplitude variation of the DC offset included in the received signal at every segment and quickly recognizing existence of the moving ghost from the estimated DC value. Additionally, the control system can be constructed using a simple hardware implementation to unload (i.e., reduce the processing burden on) the micro-controller controlling the receiver chip.

While the present invention has been shown and described with respect to the particular embodiments, it will be apparent to those skilled in the art that many changes and modifications may be made without departing from the spirit and the scope of the invention as defined in the appended claims.

What is claimed is:

1. A system for controlling an adaptive equalizer, the system comprising:
a DC estimator for estimating a DC value included in a received baseband signal;
a maximum outputting unit for extracting a maximum DC value from the estimated DC value from the DC estimator;
a minimum outputting unit for extracting a minimum DC value from the estimated DC value from the DC estimator;
a initializing circuit for initializing the maximum outputting unit and the minimum outputting unit to a new DC value applied at every a predetermined number of field periods;
operating means coupled to the maximum outputting unit and the minimum outputting unit for obtaining a difference between the maximum DC value and the minimum DC value;
a computing unit coupled to the maximum outputting unit and the minimum outputting unit for obtaining a median value between the maximum DC value and the minimum DC value;
storing means for storing thresholds for the DC value and outputting one of the thresholds corresponding to the median value from the computing unit;
a comparator for comparing the difference between the maximum DC value and the minimum DC value from the operating means with the one of the thresholds outputted from the storing means; and
a controller for changing an operation mode of the adaptive equalizer to a blind mode when the difference between the maximum DC value and the minimum DC value is larger than the one of the thresholds in response to a comparison result from the comparator and changing the operation mode of the adaptive equalizer to a training mode when a count number is larger than a predetermined number after a counting operation operated in response to a segment synchronization signal when the difference between the maximum DC value and the minimum DC value is smaller than the one of the thresholds.

2. The system as recited in claim 1, wherein the initializing circuit initializes the maximum outputting unit and the minimum outputting unit at every 512 field synchronizations.

3. The system as recited in claim 1, wherein the controller initializes the count number when the difference between the maximum DC value and the minimum DC value is larger than the one of the thresholds during the counting operation.

4. The system as recited in claim 2, wherein the controller initializes the count number when the difference between the maximum DC value and the minimum DC value is larger than the one of the thresholds during the counting operation.

5. A method for controlling operation modes of an adaptive equalizer, a method comprising:
estimating a DC value from a received baseband signal;
obtaining a maximum DC value and a minimum DC value from the estimated DC value;
comparing a difference between the maximum DC value and the minimum DC value with a threshold responsive to the estimated DC value;
changing an operation mode of the adaptive equalizer to a blind mode if the difference between the maximum DC value and the minimum DC value is larger than the threshold;
counting a count number in response to a segment synchronization signal if the difference between the maximum DC value and the minimum DC value is smaller than the threshold;
comparing the count number with a predetermined number; and
changing the operation mode of the adaptive equalizer to a training mode if the count number is larger than the predetermined number after repeating counting if the difference between the maximum DC value and the minimum DC value is smaller than the threshold.

6. The method as recited in claim 5, wherein the threshold is established based on a median value of the maximum DC value and the minimum DC value.
